(19) United States
(12) Patent Application Publication
(10) Pub. No.: US 2021/0064694 A1
(43) Pub. Date: Mar. 4, 2021

(54) TEMPLATED FORM GENERATION FROM META MODEL BASED RULES WITH CONCURRENT EDITING

(71) Applicant: Mentor Graphics Corporation, Wilsonville, OR (US)

(72) Inventors: Christopher Schmitz, Portland, OR (US); Eric E. Thompson, Portland, OR (US); Darcy J. McCallum, Portland, OR (US)

(21) Appl. No.: 16/556,522

(22) Filed: Aug. 30, 2019

(51) Int. Cl. G06F 17/24; G06F 16/176; G06F 17/21

(52) U.S. Cl. CPC G06F 17/243; G06F 17/211; G06F 17/248; G06F 16/1774

(57) ABSTRACT

This application discloses a computing system implementing a management system to generate a presentation populated with a portion of a meta model in response to a meta model access request for a first client device. The presentation includes one or more editable fields capable of data entry by the first client device. The management system receives an indication that the first client device utilized at least one of the editable fields of the presentation to initiate a modification to the portion of the meta model, and locks a second client device from modifying the portion of the meta model. When the first client device completes the modification to the portion of the meta model, the management system updates the portion of the meta model based on the modification to the portion of the meta model and unlocks the second client device from modifying the portion of the meta model.

### TECHNICAL FIELD

This application is generally related to memory system access and, more specifically, to templated form generation from meta model based rules with concurrent editing.

### BACKGROUND

Electronic design automation (EDA) tools can allow users to design and analyze electronic devices or systems. These electronic design automation tools are typically tailored to perform a specific design task or set of design tasks, such as generate system level requirements, develop system architectures, perform electronic or network design, or the like. In developing an electronic system, engineering teams often employ multiple different electronic design automation tools, many times in tandem, to separately develop portions of the electronic system and then subsequently attempt to integrate them into a final electronic system design. While this development strategy can ultimately allow the engineering team to build the electronic system, the integration of the separately developed portions of the electronic system is difficult and usually leads to iterative re-design.

The difficulty with integrating the separately developed portions of the electronic system typically stems from the fact that the multiple different electronic design automation tools are typically developed as stand-alone tools, which are often not integrated during the design process. Thus, a design choice or alteration to a design made in one electronic design automation tool can have ripple effects to other portions of the electronic system design, which often are not be realized until there was an attempt to integrate the separately developed portions of the electronic system design.

In an attempt to reduce a number of re-designs of the design process, some system design tools allow design teams to generate an integrated characterization of the data expected to be developed and then build the electronic system design referencing the integrated characterization of the data to ensure compatibility from different design tools. Often, however, the design teams may decide to update the integrated characterization of the data during the design process, which can impact performance of design task by the different design tools and stifle the integrated development approach when the updated integrated characterization of the data was improperly cascaded to the distributed design teams.

### SUMMARY

This application discloses a computing system implementing a management system to generate a presentation populated with a portion of a meta model in response to a meta model access request for a first client device. The presentation includes one or more editable fields capable of data entry by the first client device. The management system receives an indication that the first client device utilized at least one of the editable fields of the presentation to initiate a modification to the portion of the meta model, and locks a second client device from modifying the portion of the meta model. When the first client device completes the modification to the portion of the meta model, the management system updates the portion of the meta model based on the modification to the portion of the meta model and unlocks the second client device from modifying the portion of the meta model. Embodiments of will be described below in greater detail.

### DESCRIPTION OF THE DRAWINGS

FIG. 1 illustrates an example distributed database environment according to various embodiments.

FIGS. 2 and 3 illustrate an example of a computer system that may implement various embodiments of the management system and/or client system.

FIG. 4 illustrates an example of a project environment according to various embodiments.

FIG. 5 illustrates an example display window having a meta model interface pane according to various embodiments.

FIG. 6 illustrates an example flowchart for implementing presentation of a meta model data with concurrent editing according to various embodiments.

### DETAILED DESCRIPTION

### Illustrative Operating Environment

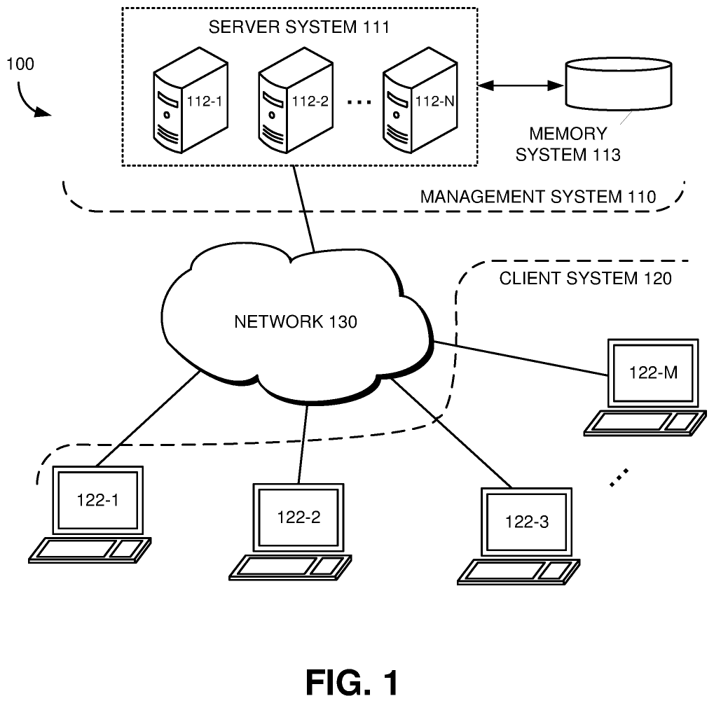

FIG. 1 illustrates an example distributed database system 100 according to various embodiments. Referring to FIG. 1, the distributed database system 100 includes a server-side, for example, a management system 110, and a client-side, for example, a client system 120, which can communicate with each other over a network 130. The server-side can include the server system 111 to implement the management environment for the client-side of the distributed database system 100. In some embodiments, the server system 111 can include multiple servers 112-1 to 112-N or other processing devices capable of implementing the management environment for the client system 120. The servers 112-1 to 112-N can access a memory system 113 storing a meta model describing a framework for a project and associated stored project data.

The meta model can be an extensible data structure capable of defining the framework for the project, which can describe the types of project data expected to be generated for the project by the client system 120. For example, when the project corresponds to a system-level design of an electronic system, the meta model can describe the electronic system by specifying various features and/or characteristics of the electronic system as a collection of objects, which can be assigned attributes that identify the various features or characteristics associated with the objects. The meta model can include objects that correspond to the components, portions, features, or the like, of the framework. Each of the objects includes one or more attributes, which can define at least one characteristic of the types of project data expected to be correlated to the objects. In some embodiments, the attributes can describe physical or functional aspects of the object, describe a relationship to another object, or the like. The meta model also can include rules having conditional action statements, which can be associated with particular objects or attributes. When a computing system correlates project data to the objects and the attributes, the rules can prompt the computing system to compare the correlated project data against a condition in the conditional action statement and selectively perform an action, such as a non-congruency notification, based on the comparison. The rules also can describe an interface definition for the meta model, for example, describing a layout and/or format for a presentation of portion of the meta model. The rules can be altered over time, for example, based on the project data correlated to the objects associated with the rules, a change in relationships between objects associated with the rules. In some embodiments, the alteration of the rules can include adding an extended set of rules corresponding to the objects, the correlated data, and/or the relationships between objects. Embodiments of the meta model will be described below in greater detail.

The client-side, for example, the client system 120, can include multiple client devices 122-1 to 122-M, which can communicate with the server system 111 directly or through a network 130. The client devices 122-1 to 122-M can be computers, laptops, workstations, tablets, handsets, or other processing devices capable of communicating with the context server system 111 directly or over the network 130. The network 130 can include one or more packet-switched networks, one or more circuit-switched networks, a combination of both, or the like, which can exchange communication between the server-side and the client-side over wired, wireless, cellular, or any other transmission medium.

The client devices 122-1 to 122-M can issue requests to access or mutate project data stored by the server system 111 through an application programmable interface (API) implemented by at least one of the servers 112-1 to 112-N. The servers 112-1 to 112-N can utilize the requests to access or mutate data in the memory system 113. The client devices 122-1 to 122-M also can issue requests to access the meta model corresponding to the project data, and the servers 112-1 to 112-N can utilize the requests to access the meta model in the memory system 113 and present the accessed meta model to the client devices 122-1 to 122-M. In some embodiments, the management system 110 can provide the requested portion of the meta model to the client system 120 using a templated form. The templated form can present the requested portion of the meta model and allow the client system 120 to perform data entry to modify the requested portion of the meta model. When multiple templated forms have been presented corresponding to a common portion of the meta model, the management system 110 can determine when modifications have been entered into one of the templated forms and lock editing from occurring in other templated forms for the common portion of the meta model. After the modification has been finalized in the templated form, the management system 110 can provide a distributed update to the templated forms presented in the client system 120 that have sections corresponding to the modified portion of the meta model. Embodiments of meta model presentation and modification via templated forms will be described below in greater detail.

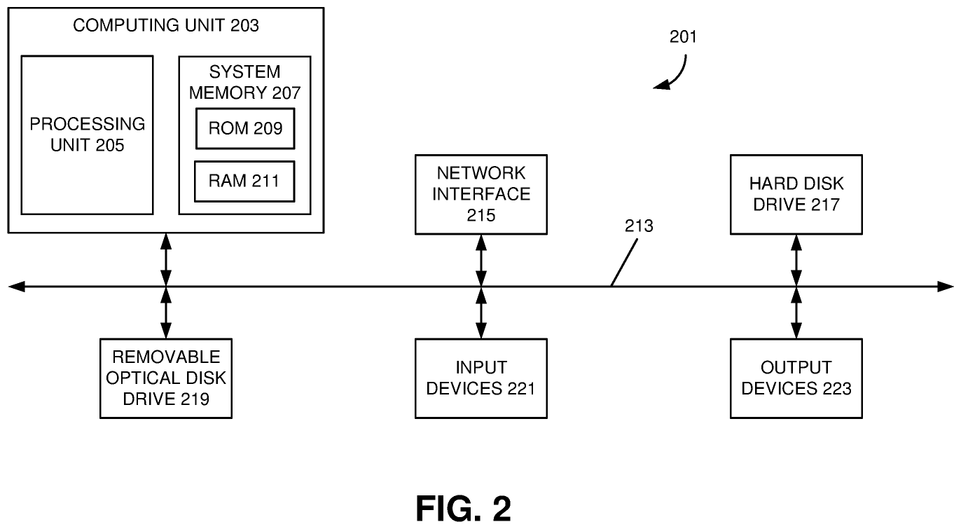

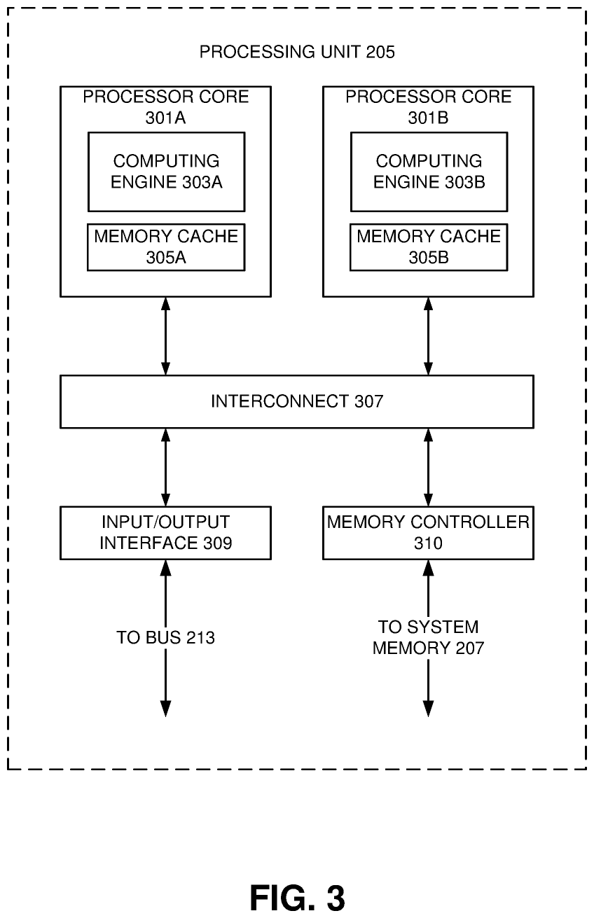

FIGS. 2 and 3 illustrate an example of a computer system that may implement various embodiments of the management system and/or client system. Referring to FIGS. 2 and 3, various examples may be implemented through the execution of software instructions by a computing device 201, such as a programmable computer. Accordingly, FIG. 2 shows an illustrative example of a computing device 201. As seen in this figure, the computing device 201 includes a computing unit 203 with a processor unit 205 and a system memory 207. The processor unit 205 may be any type of programmable electronic device for executing software instructions, but will conventionally be a microprocessor. The system memory 207 may include both a read-only memory (ROM) 209 and a random access memory (RAM) 211. As will be appreciated by those of ordinary skill in the art, both the read-only memory (ROM) 209 and the random access memory (RAM) 211 may store software instructions for execution by the processor unit 205.

The processor unit 205 and the system memory 207 are connected, either directly or indirectly, through a bus 213 or alternate communication structure, to one or more peripheral devices 215-223. For example, the processor unit 205 or the system memory 207 may be directly or indirectly connected to one or more additional memory storage devices, such as a hard disk drive 217, which can be magnetic and/or removable, a removable optical disk drive 219, and/or a flash memory card. The processor unit 205 and the system memory 207 also may be directly or indirectly connected to one or more input devices 221 and one or more output devices 223. The input devices 221 may include, for example, a keyboard, a pointing device (such as a mouse, touchpad, stylus, trackball, or joystick), a scanner, a camera, and a microphone. The output devices 223 may include, for example, a monitor display, a printer and speakers. With various examples of the computing device 201, one or more of the peripheral devices 215-223 may be internally housed with the computing unit 203. Alternately, one or more of the peripheral devices 215-223 may be external to the housing for the computing unit 203 and connected to the bus 213 through, for example, a Universal Serial Bus (USB) connection.

With some implementations, the computing unit 203 may be directly or indirectly connected to a network interface 215 for communicating with other devices making up a network. The network interface 215 can translate data and control signals from the computing unit 203 into network messages according to one or more communication protocols, such as the transmission control protocol (TCP) and the Internet protocol (IP). Also, the network interface 215 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 201 is illustrated as an example only, and it not intended to be limiting. Various embodiments may be implemented using one or more computing devices that include the components of the computing device 201 illustrated in FIG. 2, which include only a subset of the components illustrated in FIG. 2, or which include an alternate combination of components, including components that are not shown in FIG. 2. For example, various embodiments may be implemented using a multi-processor computer, a plurality of single and/or multiprocessor computers arranged into a network, or some combination of both.

With some implementations, the processor unit 205 can have more than one processor core. Accordingly, FIG. 3 illustrates an example of a multi-core processor unit 205 that may be employed with various embodiments. As seen in this figure, the processor unit 205 includes a plurality of processor cores 301A and 301B. Each processor core 301A and 301B includes a computing engine 303A and 303B, respectively, and a memory cache 305A and 305B, respectively. As known to those of ordinary skill in the art, a computing engine 303A and 303B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 303A and 303B may then use its corresponding memory cache 305A and 305B, respectively, to quickly store and retrieve data and/or instructions for execution.

Each processor core 301A and 301B is connected to an interconnect 307. The particular construction of the interconnect 307 may vary depending upon the architecture of the processor unit 205. With some processor cores 301A and 301B, such as the Cell microprocessor created by Sony Corporation, Toshiba Corporation and IBM Corporation, the interconnect 307 may be implemented as an interconnect bus. With other processor units 301A and 301B, however, such as the Opteron™ and Athlon™ dual-core processors available from Advanced Micro Devices of Sunnyvale, Calif., the interconnect 307 may be implemented as a system request interface device. In any case, the processor cores 301A and 301B communicate through the interconnect 307 with an input/output interface 309 and a memory controller 310. The input/output interface 309 provides a communication interface to the bus 213. Similarly, the memory controller 310 controls the exchange of information to the system memory 207. With some implementations, the processor unit 205 may include additional components, such as a high-level cache memory accessible shared by the processor cores 301A and 301B. It also should be appreciated that the description of the computer network illustrated in FIG. 2 and FIG. 3 is provided as an example only, and it not intended to suggest any limitation as to the scope of use or functionality of alternate embodiments.

### Meta Model Interface Implementation

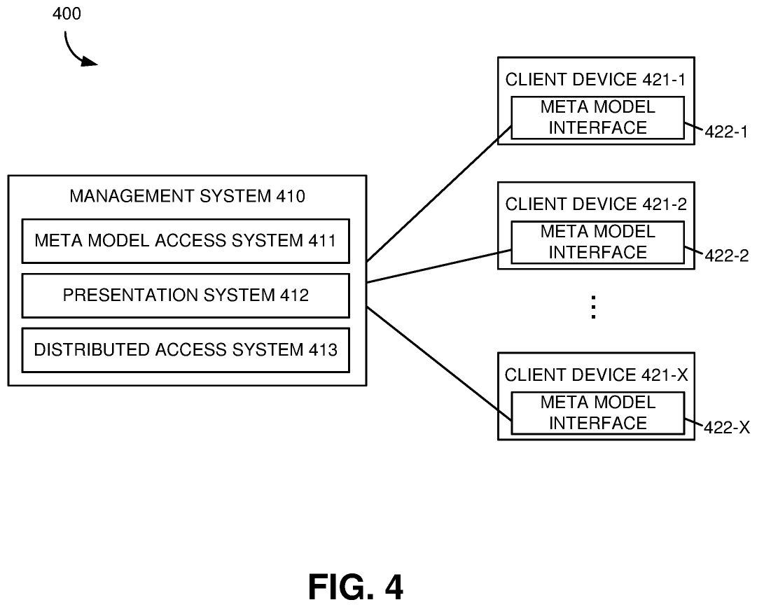

FIG. 4 illustrates an example of a project environment 400 according to various embodiments. Referring to FIG. 4, the project environment 400 includes multiple client devices 421-1 to 421-X capable of generating project data and correlating the project data to a meta model. The meta model can be an extensible data structure capable of defining a framework for a project, which can describe the types of project data expected to be generated for the project by the client devices 421-1 to 421-X. The meta model can include objects that correspond to the components, portions, features, or the like, of the framework. Each of the objects includes one or more attributes, which can define at least one characteristic of the types of project data expected to be correlated to the objects. In some embodiments, the attributes can describe physical or functional aspects of the object, describe a relationship to another object, or the like. The objects can be arranged in a flat structure relative to each other or in a hierarchical structure, for example, based on common attributes. This hierarchical structure can allow objects to have attributes defined or assigned to them directly and/or for them to inherit attributes from other (higher-level) objects.

The meta model also can provide additional functionality, which allows the meta model, when executed by a computing system, to prompt or direct the computing system to perform various operations based on a content of the project data correlated to the objects and/or attributes. For example, the meta model can include rules having conditional action statements, which can be associated with particular objects or attributes. When a computing system correlates project data to the objects and the attributes, the rules can prompt the computing system to compare the correlated project data against a condition in the conditional action statement and selectively perform an action, such as a non-congruency notification, based on the comparison. The computing system also can perform other operations based on attributes. For example, when the computing system identifies that multiple objects are related based on an attribute, the computing system can compare correlated data for each of the objects to check for congruency, and then selectively perform an action, such as a non-congruency notification, based on the comparison.

The project environment 400 includes a management system 410 to store the meta model and to manage or integrate the project data generated by the client devices 421-1 to 421-X, for example, utilizing the framework for the project described by the meta model. The management system 410 can correlate the project data to different objects in the meta model. In some embodiments, the management system 410 can correlate the project data to the meta model by associating or linking the project data to different objects or attributes in the meta model. For example, when the meta model describes an electronic system and has an object corresponding to an external reset functionality, the management system 410 can associate project data from one or more electronic system designs, such as a reset pin or port and/or reset circuitry, to the object in the meta model. This association of design data to objects in the meta model can correspond to the correlation of the designs (or portions thereof) developed by the client devices 421-1 to 421-X to the meta model.

The management system 410 can determine whether project data correlated to the meta model is congruent with the framework described in the meta model. The management system 410, in some embodiments, can utilize the structure of the framework, such as the object and attributes, and any project data from the client devices 421-1 to 421-X to identify whether the project data conforms with the framework described in the meta model. Since management system 410 correlates portions of the designs from the design system 120 to the framework, the management system 410 can analyze the correlated portions of the designs to determine whether the data in the correlated portions of the designs conform to data expected by the framework. For example, when the framework includes an object correlated to an input/output (I/O) interface in one of the designs, the management system 410 can utilize the attributes of the object to determine whether the design for the I/O interface performs certain functions, operates within certain electrical specifications, or the like. The management system 410 also can utilize the object to identify related objects, such as circuitry from a different design intended to couple or connect to the I/O interface, and utilize the attributes of both objects to determine whether there is congruency between the two designs and/or congruency with the system-level design described in the framework.

Each of the client devices 421-1 to 421-X can include a corresponding meta model interface 422-1 to 422-X, which can communicate with the management system 410. The meta model interface 422-1 to 422-X can be utilized by the client devices 421-1 to 421-X to request access to the meta model stored by the management system 410. The client device 421-1 to 421-X can issue one or more meta model access requests to the management system 410 via the meta model interfaces 422-1 to 422-X, which can prompt the management system 410 to present a presentation of the requested portion(s) of the metal model to the client devices 421-1 to 421-X via the meta model interfaces 422-1 to 422-X. The meta model interfaces 422-1 to 422-X can be utilized by the client devices 421-1 to 421-X to present the requested portion(s) of the metal model, to allow editing of the presented portion(s) of the meta model, and to update the requested portion(s) of the meta model when another one of the client devices 421-1 to 421-X modified the meta model.

The management system 410 can include a meta model access system 411 to receive the meta model access requests from the meta model interfaces 422-1 to 422-X in the client devices 421-1 to 421-X. The meta model access system 411 can parse the meta model access requests to identify one or more portions of the meta model that was requested for presentation in the client devices 421-1 to 421-X. The meta model access system 411 can retrieve the requested portions of the meta model from a memory system, such as a data base, for presentation to the client devices 421-1 to 421-X.

The management system 410 can include a presentation system 412 to generate a presentation that includes the requested portions of the meta model and transmit the presentation to the client devices 421-1 to 421-X that issued the meta model access requests. In some embodiments, the presentation system 412 can store one or more templated forms capable of population with portions of the meta model. The templated forms, when presented via the meta model interfaces 422-1 to 422-X in the client devices 421-1 to 421-X, can include fields that allow for modification of the portions of the meta model or additions to the meta model. In some embodiments, the rules in the meta model can define an interface format for the object(s) and attribute(s) associated with the rules, and the presentation system 412 can utilize the interface format to select and/or populate a templated form with requested portions of the meta model. In some embodiments, the presentation system 412 can include descriptions of formats available for presenting different portions of the meta model, and utilize the identified portions of the meta model requested for presentation to select one of the descriptions of formats for use in generating the presentation to the client devices 421-1 to 421-X. The presentation system 412 can utilize the selected format description to identify at least one templated form to populate with the requested portions of the meta model in order to generate the presentation to the client devices 421-1 to 421-X.

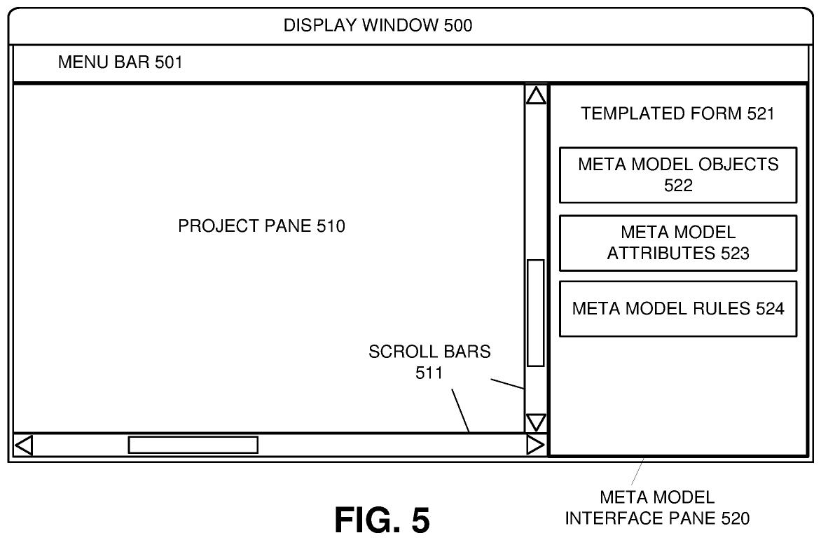

The meta model interfaces 422-1 to 422-X in the client devices 421-1 to 421-X can receive the meta model presentation, such as a templated form populated with requested portions of the meta model, and display the meta model presentation on a graphical user interface. The client devices 421-1 to 421-X can receive user input corresponding to the meta model presentation, such as data entry or data modification operations, and the meta model interfaces 422-1 to 422-X can modify the meta model presentation based on the user input. The meta model interfaces 422-1 to 422-X also can prompt the client devices 421-1 to 421-X to transmit an indication of the meta model presentation modification to the management system 410. Embodiments of the meta model presentation will be described below with reference to FIG. 5.

FIG. 5 illustrates an example display window 500 having a meta model interface pane 520 according to various embodiments. Referring to FIG. 5, the display window 500 can include a project pane 510 to allow for development of a project data, such as design data for at least a portion of an electronic system, and include the meta model interface pane 520 to present portions of the meta model. The project pane 510 can include scroll bars 511, that, when selected or moved, for example, in response to user input, can adjust which portions of a design are viewable in the project pane 510. The design tool display window 500 can include a menu bar 501 having various mechanisms to selectively sort, filter, organize, populate, or the like, design in the project pane 510 and/or the meta model interface pane 520.

The meta model interface pane 520 can include a templated form 521 having multiple different fields to present information corresponding to the meta model. The templated form 521 can include meta model objects 522 fields capable of being populated with names and/or descriptions of objects in the meta model. In some embodiments, the meta model interface pane 520 can selectively render the meta model objects 522 fields editable, for example, allowing modifications to objects in the meta model or additions of new objects to the meta model.

The templated form 521 can include meta model attributes 523 fields capable of being populated with names and/or descriptions of attributes in the meta model. In some embodiments, the attributes listed in the meta model attributes 523 fields can correspond to the attributes associated with one or more objects in the meta model objects 522 fields. In some embodiments, the meta model interface pane 520 can selectively render the meta model attributes 523 fields editable, for example, allowing modifications to attributes in the meta model or additions of new attributes for objects in the meta model.

The templated form 521 can include meta model rules 524 fields capable of being populated with descriptions of rules in the meta model. In some embodiments, the rules listed in the meta model rules 524 fields can correspond to the rules or conditions associated with one or more objects in the meta model objects 522 fields. In some embodiments, the meta model interface pane 520 can selectively render the meta model rules 524 fields editable, for example, allowing modifications to rules in the meta model or additions of new rules for objects in the meta model.

Referring back to FIG. 4, the management system 410 can include a distributed access system 413 to maintain records of the meta model presentations transmitted to the client devices 421-1 to 421-X, which can identify the portions of the meta model that were accessed to generate the meta model presentation. The distributed access system 413 can identify when the client devices 421-1 to 421-X via the meta model interfaces 422-1 to 422-X have edited the meta model presentations to modify the portions of the meta model. When the distributed access system 413 determines that different meta model presentations include edits to different portions of the meta model, the distributed access system 413 can allow the client devices 421-1 to 421-X corresponding to the different meta model presentations to concurrently edit the different portions of the meta model.

When the distributed access system 413 can receives an indication that one of the meta model interfaces 422-1 to 422-X in the client devices 421-1 to 421-X has initiated a meta model modification or addition, the distributed access system 413 can lock the portions of the meta model corresponding to the indication from being modified by any other client device 421-1 to 421-X. In some embodiments, the distributed access system 413 can prompt the presentation system 412 to update the meta model presentation to remove editable fields corresponding to the portions of the meta model associated with the indication. For example, the presentation system 412 can select a different templated form having different editable fields to populate with meta model data provide to the meta model interfaces 422-1 to 422-X in the client devices 421-1 to 421-X.

The management system 410 can receive an indication that the meta model modification or addition has been completed, which can prompt the meta model access system 412 to store the modifications or additions to the meta model and prompt the distributed access system 413 to unlock the modified or added portions of the meta model from being modified by any other client device 421-1 to 421-X. In some embodiments, the distributed access system 413 can prompt the presentation system 412 to update the meta model presentation to add new portions of the meta model, add editable fields corresponding to the portions of the meta model, or the like. For example, the presentation system 412 can select a different templated form having different editable fields to populate with meta model data provide to the meta model interfaces 422-1 to 422-X in the client devices 421-1 to 421-X.

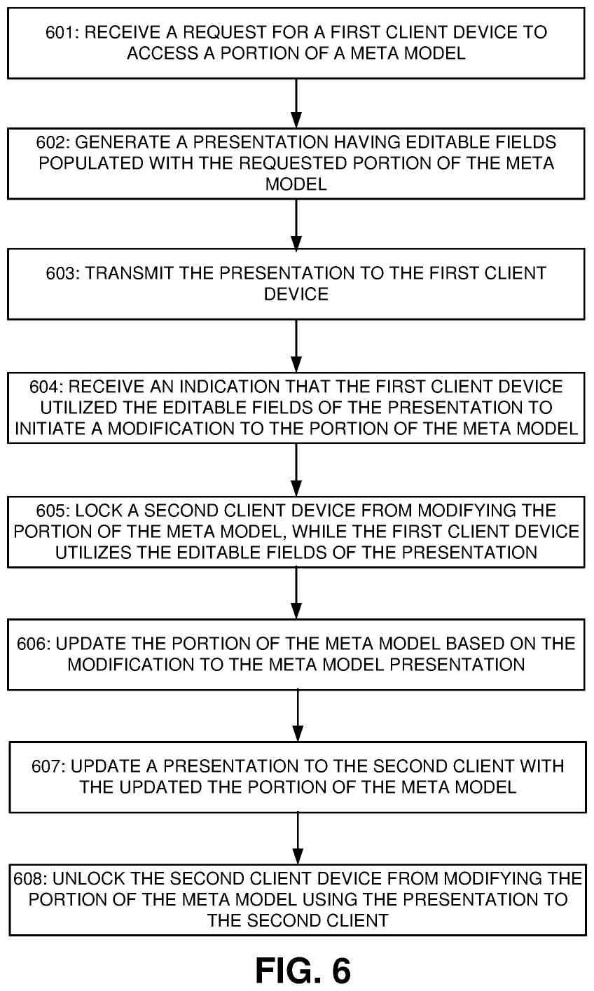

FIG. 6 illustrates an example flowchart for implementing presentation of a meta model data with concurrent editing according to various embodiments. Referring to FIG. 6, in a block 601, the management system can receive a request for a first client device to access a portion of a meta model. In some embodiments, the first client device can include a meta model interface, which can be utilized to generate the request to access the portion of the meta model, and to transmit the request to the management system.

In a block 602, the management system can generate a presentation having editable fields populated with the requested portion of the meta model. The management system can access request to identify the portion of the meta model that was requested for presentation in the first client device. The management system can retrieve the portion of the meta model from a memory system and generate a presentation that includes the portion of the meta model.

In some embodiments, the presentation can include a templated form having editable fields populated with the portion of the meta model. The management system can utilize the portion of the meta model, such as the rules in the meta model, to identify a layout or format for the portion of the meta model in the presentation, and generate the presentation with the templated form based on the identified layout or format.

In a block 603, the management system can transmit the presentation to the first client device. The meta model interface in the first client device can receive the presentation, such as a templated form populated with portion of the meta model, and display the presentation on a graphical user interface.

In a block 604, the management system can receive an indication that the first client device utilized the editable fields of the presentation to initiate a modification to the portion of the meta model. The first client device can receive user input corresponding to the presentation, such as data entry or data modification operations to the editable fields in the presentation, and the meta model interface can modify the presentation based on the user input. The meta model interface also can prompt the first client device to generate and transmit the indication of the presentation modification to the management system.

The management system can maintain records of meta model presentations transmitted to the first and second client devices, which can identify the portions of the meta model that were accessed to generate the meta model presentations. When the management system determines that the indication of the presentation modification corresponds to a portion of the meta model not provided to the second client device in a presentation, the management system can allow the first and second client devices to concurrently edit their meta model presentations.

When the management system determines that the indication of the presentation modification corresponds to a portion of the meta model provided to the second client device in a presentation, the management system can, in a block 605, can lock a second client device from modifying the portion of the meta model, while the first client device utilizes the editable fields of the presentation. In some embodiments, the management system can lock the second client device from modifying the portion of the meta model by generating a new presentation for the second client device, which removes one or more editable fields. The management system also can have an internal locking mechanism, which can refuse to effectuate a modification to the portion of the meta model by the second client device when the first client device modifies the same portion of the meta model.

After the first client device completes modification of the portion of the meta model, the management system, in a block 606, can update the stored meta model based on the modification to the portion of the meta model presentation. In some embodiments, the first client device via the meta model interface can commit the modifications to the presentation to become changes to the meta model, and transmit the presentation along with the modifications to the management system. The management system can parse the editable fields in the presentation to identify the modifications and update the portion of the meta model having been modified in the presentation.

In a block 607, the management system can update a presentation to the second client with the updated the portion of the meta model. In some embodiments, the management system, in response to updating the stored meta model, can generate a new presentation for the second client device having the updated meta model and transmit the new presentation to the second client device for display by the meta model interface.

In a block 608, the management system can unlock the second client device from modifying the portion of the meta model using the presentation to the second client. In some embodiments, the management system can allow the second client device to modify the presentation to change the portion of the meta model previously modified by the first client device.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable”may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments, those skilled in the art will appreciate that there are numerous variations and permutations of the above described systems and techniques that fall within the spirit and scope as set forth in the appended claims.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
generating, by a computing system, a presentation populated with a portion of a meta model in response to a request for a first client device to access the portion of the meta model, wherein the presentation includes one or more editable fields capable of data entry by the first client device;
receiving, by the computing system, an indication that the first client device utilized at least one of the editable fields of the presentation to initiate a modification to the portion of the meta model;
locking, by the computing system, a second client device from modifying the portion of the meta model, while the first client device utilizes the editable fields of the presentation; and
when the first client device completes the modification to the portion of the meta model, updating, by the computing system, the portion of the meta model based on the modification to the portion of the meta model and allowing the second client device to modify the updated portion of the meta model.

2. The method of claim 1, wherein the presentation corresponds to a templated form having the editable fields and populated with the portion of the meta model, and wherein generating the presentation further comprises identifying a format for the portion of the meta model and generating the templated form based on the identified format.

3. The method of claim 1, wherein locking the second client device from modifying the portion of the meta model further comprises removing an editable field from a presentation of the portion of the meta model available to the second client device.

4. The method of claim 1, wherein locking the second client device from modifying the portion of the meta model further comprises generating a presentation for the second client device without an editable field corresponding to the portion of the meta model.

5. The method of claim 1, wherein allowing the second client device to modify the portion of the meta model further comprises incorporating an editable field corresponding to the portion of the meta model into the presentation of the for the second client device.

6. The method of claim 1, wherein the meta model includes objects, attributes that describe characteristics of the objects, and rules associated with the attributes.

7. The method of claim 6, wherein the objects are arranged in the meta model in a hierarchical structure based, at least in part, on common attributes, and wherein the hierarchical structure allows the objects to have corresponding attributes or rules assigned to them directly or inherit the corresponding attributes or rules from other objects at a higher-level in the hierarchical structure.

8. A system comprising:
a memory device configured to store machine-readable instructions; and
a computing system including one or more processing devices, in response to executing the machine-readable instructions, configured to:
generate a presentation populated with a portion of a meta model in response to a request for a first client device to access the portion of the meta model, wherein the presentation includes one or more editable fields capable of data entry by the first client device;
receive an indication that the first client device utilized at least one of the editable fields of the presentation to initiate a modification to the portion of the meta model;
lock a second client device from modifying the portion of the meta model, while the first client device utilizes the editable fields of the presentation; and
when the first client device completes the modification to the portion of the meta model, update the portion of the meta model based on the modification to the portion of the meta model and allowing the second client device to modify the updated portion of the meta model.

9. The system of claim 8, wherein the presentation corresponds to a templated form having the editable fields and populated with the portion of the meta model, and wherein the one or more processing devices, in response to executing the machine-readable instructions, are further configured to identify a format for the portion of the meta model and generate the templated form based on the identified format.

10. The system of claim 8, wherein the one or more processing devices, in response to executing the machine-readable instructions, are further configured to lock the second client device from modifying the portion of the meta model by removing an editable field from a presentation of the portion of the meta model available to the second client device.

11. The system of claim 8, wherein the one or more processing devices, in response to executing the machine-readable instructions, are further configured to lock the second client device from modifying the portion of the meta model by generating a presentation for the second client device without an editable field corresponding to the portion of the meta model.

12. The system of claim 8, wherein the one or more processing devices, in response to executing the machine-readable instructions, are further configured to allow the second client device to modify the portion of the meta model by incorporating an editable field corresponding to the portion of the meta model into the presentation of the for the second client device.

13. The system of claim 8, wherein the meta model includes objects, attributes that describe characteristics of the objects, and rules associated with the attributes, wherein the objects are arranged in the meta model in a hierarchical structure based, at least in part, on common attributes, and wherein the hierarchical structure allows the objects to have corresponding attributes or rules assigned to them directly or inherit the corresponding attributes or rules from other objects at a higher-level in the hierarchical structure.

14. An apparatus comprising at least one computer-readable memory device storing instructions configured to cause one or more processing devices to perform operations comprising:
generating a presentation populated with a portion of a meta model in response to a request for a first client device to access the portion of the meta model, wherein the presentation includes one or more editable fields capable of data entry by the first client device;
receiving an indication that the first client device utilized at least one of the editable fields of the presentation to initiate a modification to the portion of the meta model;
locking a second client device from modifying the portion of the meta model, while the first client device utilizes the editable fields of the presentation; and
when the first client device completes the modification to the portion of the meta model, updating the portion of the meta model based on the modification to the portion of the meta model and allowing the second client device to modify the updated portion of the meta model.

15. The apparatus of claim 14, wherein the presentation corresponds to a templated form having the editable fields and populated with the portion of the meta model, and wherein generating the presentation further comprises selecting a format for the portion of the meta model and identifying the templated form based on the selected format.

16. The apparatus of claim 14, wherein locking the second client device from modifying the portion of the meta model further comprises removing an editable field from a presentation of the portion of the meta model available to the second client device.

17. The apparatus of claim 14, wherein locking the second client device from modifying the portion of the meta model further comprises generating a presentation for the second client device without an editable field corresponding to the portion of the meta model.

18. The apparatus of claim 14, wherein allowing the second client device to modify the portion of the meta model further comprises incorporating an editable field corresponding to the portion of the meta model into the presentation of the for the second client device.

19. The apparatus of claim 14, wherein the meta model includes objects, attributes that describe characteristics of the objects, and rules associated with the attributes.

20. The apparatus of claim 19, wherein the objects are arranged in the meta model in a hierarchical structure based, at least in part, on common attributes, and wherein the hierarchical structure allows the objects to have corresponding attributes or rules assigned to them directly or inherit the corresponding attributes or rules from other objects at a higher-level in the hierarchical structure.
